(19) United States
(12) Patent Application Publication
(10) Pub. No.: US 2026/0157595 A1
(43) Pub. Date: Jun. 11, 2026

(54) DOOR LATCH AND OPENER FOR AN APPLIANCE

(71) Applicant: ILLINOIS TOOL WORKS INC., GLENVIEW, IL (US)

(72) Inventors: Nicola SARTORI, Comerio (IT); Gianluca GAUDIO, Sumirago (IT)

(73) Assignee: ILLINOIS TOOL WORKS INC., GLENVIEW, IL (US)

(21) Appl. No.: 19/410,574

(22) Filed: Dec. 5, 2025

(30) Foreign Application Priority Data
Dec. 9, 2024 (EP) 24218472.9
Nov. 11, 2025 (EP) 25215046.1

(51) Int. Cl. A47L 15/42; E05B 15/04; E05B 47/00

(52) U.S. Cl. CPC A47L 15/4259; E05B 15/04; E05B 47/0001

(57) ABSTRACT

A door latch and opener (200) for a dishwasher (100) having a door. The door latch and opener includes a latch member (204) for engagement with a striker (104) of the dishwasher. The latch member is movable between a closed position for holding the door (106) closed and an open position for releasing the striker. The door latch and opener also includes an opening mechanism (208) including an actuator coupled to the latch member. The opening mechanism is operable to move the latch member from the closed position to the open position.

### CROSS-REFERENCE TO RELATED APPLICATIONS

European Patent Application Nos. EP 24218472.9, filed on 9 Dec. 2024 and EP 25215046.1, filed 11 Nov. 2025, the priority documents corresponding to this invention, to which a foreign priority benefit is claimed under Title 35, United States Code, Section 119, and their entire teachings are incorporated, by reference, into this specification.

### BACKGROUND OF THE INVENTION

### Field of the Invention

The present invention relates to a door latch and opener for an appliance, in particular a dishwasher.

### SUMMARY OF THE INVENTION

According to the present invention, there is provided a door latch and opener for a dishwasher having a door, the door latch and opener comprising:
a latch member for engagement with a striker of the dishwasher, the latch member being movable between a closed position for holding the door closed and an open position for releasing the striker, and
an opening mechanism comprising an actuator coupled to the latch member and operable to move the latch member from the closed position to the open position.

Advantageously, the door latch and opener provides two functions: latching the door in a closed position during use, and opening the door (e.g., at the end of a cleaning cycle).

In examples, the latch member is configured to be movable, by a force exerted by the striker on the latch member, from the closed position and the open position, and from the open position to the closed position. In this way the door of the appliance can be manually opened and closed (causing the striker to engage the latch member), and the latch member will move between the open and closed positions accordingly. In other words, the door latch and opener provides for manually opening and closing the door, and also includes the opening mechanism for automatically opening the door when the opening mechanism is operated.

In examples, the door latch and opener comprises a housing. The latch member may be rotationally mounted to the housing. The opening mechanism may be housed within the housing. The door latch and opener may comprise a single, integrated unit that can be mounted within a door of the appliance.

In examples, the door latch and opener further comprises an over-centre spring mechanism arranged to act on the latch member. The over-centre spring mechanism preferably has a first stable position corresponding to the closed position of the latch member and a second stable position corresponding to the open position of the latch member. The opening mechanism is operable to move the latch member from the closed position to the open position, also moving the over-centre spring mechanism. The latch member is moveable from the open position to the closed position when the door is closed, at which point the striker engages and moves the latch member into the closed position. The over-centre spring mechanism ensures that the latch member is always in either the closed position or the open position.

In examples, the over-centre spring mechanism comprises a spring within a spring housing. A first end of the spring housing may be rotationally coupled to the latch member. A second end of the spring casing may be rotationally coupled to the housing.

In examples, the opening mechanism comprises an arm coupled to the latch member. The actuator is preferably operable to act on the arm to move the latch member from the closed position to the open position.

In examples, the actuator may be a motor, a linear actuator, or a solenoid.

In examples, the opening mechanism further comprises a crank wheel. In this example the arm may be pivotally coupled to the latch member and pivotally coupled to the crank wheel. The actuator, for example a motor, may be arranged to rotate the crank wheel to move the latch member from the closed position to the open position. In particular, rotating the crank wheel may move the arm, which in turn exerts a force on the latch member.

In preferred examples the crank wheel may comprise an arcuate slot, and the arm may comprise a slider that is slidably coupled to the arcuate slot of the crank wheel. In this way, the latch member can remain in an open position while the crank wheel can be moved back to a starting position (reset position), allowing the latch member to be moved back to the closed position without the opening mechanism (e.g., by a user closing the door of the dishwasher).

In examples, the opening mechanism may be configured to:
rotate the crank wheel in a first direction to move the latch member from the closed position to the open position, during which movement the slider of the arm is at a first end of the arcuate slot, and
rotate the crank wheel in a second direction, opposite the first direction, to move the slider to a second position within the arcuate slot while the latch member remains in the open position.

Advantageously, after the crank wheel is rotated in the second direction it is possible to move the latch member back to the closed position without moving the crank wheel, because the slider will slide along the arcuate slot. This allows the latch member to be closed by pushing the door closed, which causes the striker to engage and rotate the latch member into the closed position.

In examples, the opening mechanism comprises a torque-limiting coupling arranged between the actuator and the crank wheel.

According to a further aspect of the present invention there is also provided an appliance, for example a dishwasher, comprising:
a cabinet having a striker, and
a door pivotably mounted to the cabinet and comprising the door latch and opener as described above.

In examples, the appliance comprises a spring acting on the door and urging the door towards an open position. In this way, the door opens under the spring force when the door latch and opener is in the open position.

Advantageously, the door latch and opener provides a single unit for latching and opening the door. This is in contrast to previous systems that employed a door latch and a separate door opener, for example an electrically-powered plunger that pushes the door open.

Moreover, the door latch and opener is housed entirely within the door of the appliance. Only a static striker is needed on the cabinet. This simplifies design and manufacturing over an alternative in which an electrically-powered door opener is provided in the cabinet. This is because a separate door opener in the cabinet would require a wiring loom to be routed to a location within the cabinet whereas the door already includes power that can be readily extended to the door latch and opener.

### BRIEF DESCRIPTION OF SEVERAL VIEWS OF THE DRAWINGS

Examples of the invention are described, by way of example only, with reference to the accompanying drawings, in which:

FIG. 1 illustrates an example dishwasher with a door latch and opener;

FIG. 2 illustrates the door latch and opener of the dishwasher of FIG. 1;

FIG. 3A and FIG. 3B are different views of the door latch and opener of FIG. 2 with the housing removed;

FIG. 4A illustrates the door latch and opener of FIG. 2 in a closed position;

FIG. 4B illustrates the door latch and opener of FIG. 2 in an open position;

FIG. 4C illustrates the door latch and opener of FIG. 2 in a reset position; and

FIG. 5 illustrates the actuator, gear train and torque-limiting coupling of the door latch and opener of FIG. 2.

### DESCRIPTION OF PREFERRED EMBODIMENTS

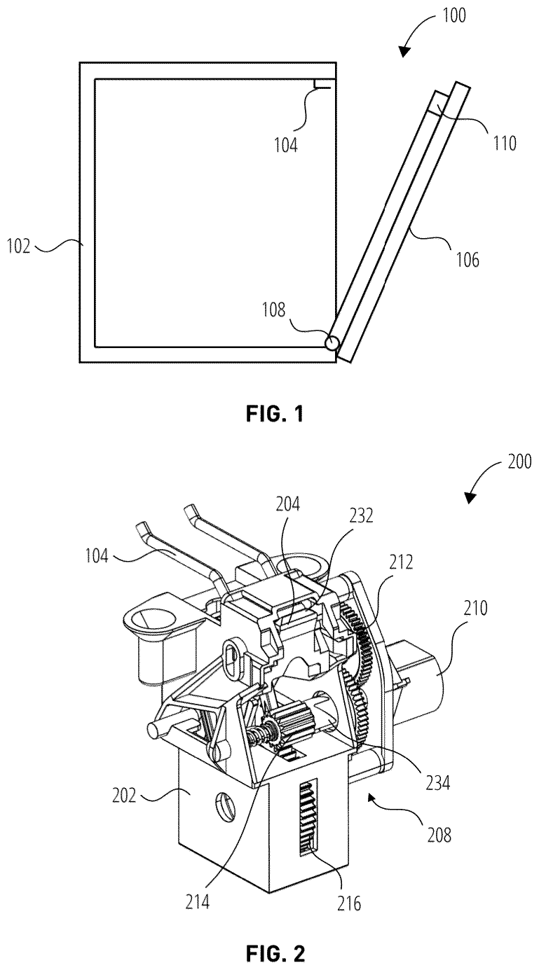

FIG. 1 shows an appliance, in particular a household appliance, in particular a dishwasher 100. The dishwasher 100 includes a cabinet 102 in which the main cavity of the dishwasher 100 is located. The dishwasher 100 also includes a door 106. The door 106 is hingedly connected to the cabinet 102 at a door hinge 108. The door hinge 108 is located at the bottom of the cabinet 102 such that the door 106 opens downwards about a horizontal axis. The cabinet 102 includes a striker 104. The striker 104 provides one part of a latching mechanism, to be described in more detail hereinafter. The striker 104 preferably includes a loop that is spaced from surfaces of the cabinet 102 and that allows a latch to attach thereto. The door 106 includes a door latch and opener 110 that engages with the striker 104 to latch the door 106 in a closed position during use of the dishwasher 100.

In examples, the door 106 may also include one or more control inputs, such as knobs or buttons, and associated power electronics. The door 106 may also include a controller or control electronics for controlling the dishwasher 100. The door 106 may also include a detergent dispenser. Power for electronic components in the door 106 may be provided through the door hinge 108.

The door hinge 108 preferably includes at least one biasing mechanism, for example a torsion spring. The biasing mechanism is arranged to bias the door towards an open position when the door is in a closed position. That is, the biasing mechanism is arranged to bias the door 106 against the latching mechanism provided by the striker 104 and the door latch and opener 110. The biasing mechanism may only bias the door 106 towards the open position in a part of the full rotational travel of the door 106, for example through only an angle that disengages the striker 104 from the door latch and opener 110. As described further hereinafter, the door latch and opener 110 acts as a door latch to hold the door 106 closed during use. The door latch and opener 110 can also disengage from the striker 104, at which point the biasing mechanism will cause the door 106 to rotate away from the cabinet 102 to disengage the door latch and opener 110 from the striker 104.

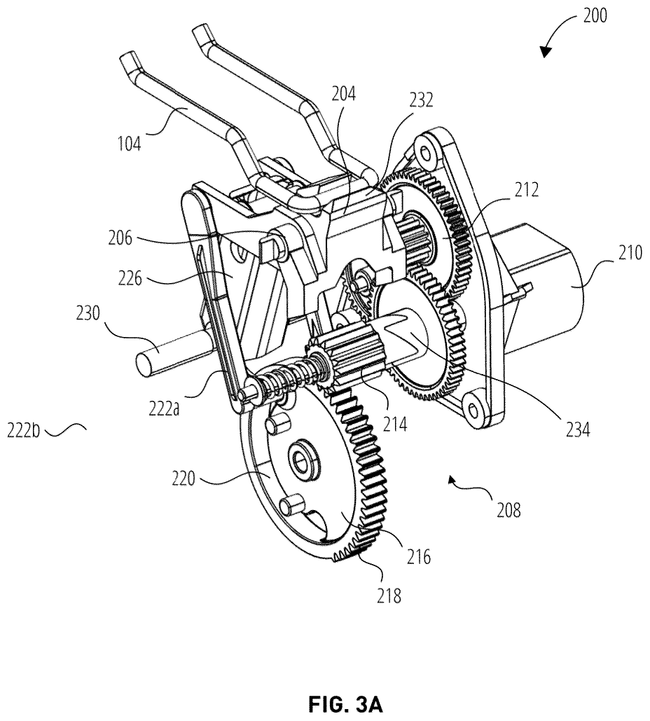

FIG. 2 to FIG. 5 show the door latch and opener 110 in more detail. In these Figures the door latch and opener 110 is indicated as 200.

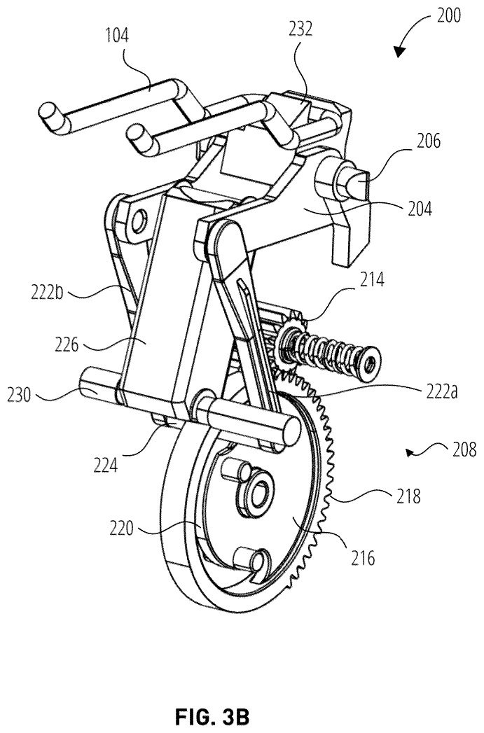

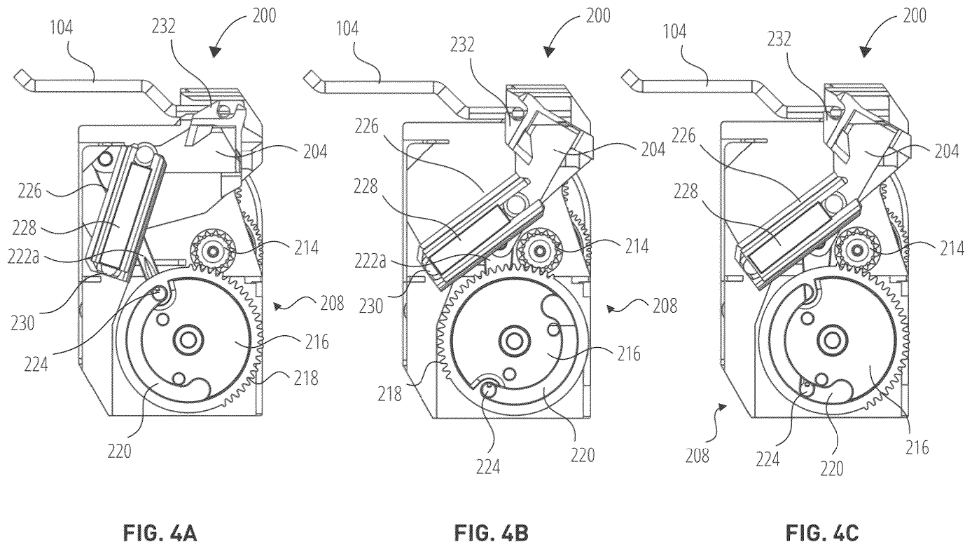

As shown in FIG. 2, the door latch and opener 200 comprises a housing 202 to which the components of the door latch and opener 200 are mounted. The door latch and opener 200 includes a latch member 204 that engages the striker 104. As shown in more detail in FIG. 3B and FIG. 4A to FIG. 4B, the latch member 204 includes a keeper 232 that engages the striker 104 when the latch member 204 is in the closed position. As described in more detail below, the latch member 204 is rotatable between the closed position in which the keeper 232 latches onto the striker 104, and open position in which the keeper 232 disengages the striker 104.

The door latch and opener 200 also includes an opening mechanism 208. The opening mechanism 208 includes an actuator, in this example a motor 210, arranged to move the latch member 204 from the closed position to the open position to disengage the striker 104 and allow the door to open as described with reference to FIG. 1.

In various examples the actuator of the opening mechanism 208 may comprise a motor, a linear actuator, a solenoid, or other actuator that moves the latch member 204 from a closed position to an open position.

In the illustrated examples the opening mechanism 208 comprises a motor 210 that drives a drive gear 214 via a gear train 212. The drive gear 214 rotates a crank wheel 216 that, as described below, actuates movement of the latch member 204.

FIG. 3A and FIG. 3B illustrate the door latch and opener 200 with the housing 202 removed for clarity. In FIG. 3A and FIG. 3B the door latch and opener 200 is in the closed position and the latch member 204, in particular the keeper 232, is engaged with the striker 104.

The latch member 204 includes the keeper 232 at one end. The latch member 204 also includes a latch member pivot 206 that is mounted to the housing 202 (see FIG. 2) such that the latch member 204 can rotate relative to the housing 202 about the latch member pivot 206. An arm 222a is pivotally connected to the latch member 204 at an end opposite to the keeper 232, with the latch member pivot 206 located between the keeper 232 and the connection to the arm 222a. In use, the arm 222a moves to rotate the latch member 204 about the latch member pivot 206, which disengages the keeper 232 from the striker 104.

As illustrated in FIG. 3B, in this example the door latch and opener 200 includes two arms 222a, 222b arranged on either side of the latch member 204 and both connected to the latch member 204 along a common axis. For clarity, only one arm 222a will be referred to in the following description.

With reference to FIG. 3A to FIG. 4B, the door latch and opener 200 also includes an over-centre spring mechanism that includes a spring 228. The spring 228 is provided within a spring housing 226 to maintain the direction of the spring 228 and to rotationally mount the spring 228 to the door latch and opener 200, as described below. The spring 228 is pivotally attached to the latch member 204 and acts on the latch member 204. The spring 228 is a compression spring. The spring 228 acts between a spring pivot 230, where the spring housing 226 is mounted to the housing 202 (see FIG. 2), and the latch member 204 at a location between the latch member pivot 206 and the arm 222a.

The spring 228 and latch member 204 are arranged such that the latch member 204 has two stable positions. The first stable position, shown in FIG. 3A, FIG. 3B, and FIG. 4A, corresponds to a closed position of the door latch and opener 200 in which the keeper 232 is positioned to engage the striker 104 and hold the door closed. The second stable position, shown in FIG. 4B, corresponds to an open position in which the latch member 204 is rotated such that the keeper 232 disengages the striker 104 and the door can open. In between the first stable position and the second stable position the latch member 204 compresses the spring 228, which pushes the latch member 204 back towards one of the stable positions according to the degree of rotation relative to an over-centre rotational position between the first and second stable positions.

In use, the force of the spring 228 holding the latch member 204 in the closed position can be overcome by a user pulling the door open. Therefore, the door latch and opener 200 permits a user to open the door at any time by pulling on the door, which rotates the latch member 204 against the spring 228 until the striker 104 and keeper 232 disengage. Opening the door in this way causes the latch member 204 to move from the first stable position (closed) to the second stable position (open).

When the door is re-closed the striker 104 will engage the latch member 204 near the keeper 232 and rotate the latch member 204 back to the closed position where the keeper 232 re-engages the striker 104 and holds the door closed. During this closing the latch member 204 is moved from the second stable position (open) back to the first stable position (closed).

Accordingly, the over-centre spring mechanism permits manual opening and closing of the door.

The opening mechanism 208 is also illustrated in FIG. 3A and FIG. 3B. The opening mechanism 208 is operable to actuate movement of the arm 222a to rotate the latch member 204 from the closed position (first stable position) to the open position (second stable position).

In the illustrated examples the opening mechanism 208 includes the motor 210, gear train 212 and drive gear 214 described above. The motor 210 is preferably a DC motor. The gear train 212 and drive gear 214 are preferable polymer gears. In some examples, the motor 210 may include reduction gearing, obviating the need for the gear train 212 between the motor 210 and the drive gear 214.

As illustrated, the drive gear 214 engages gear teeth 218 on the crank wheel 216. The crank wheel 216 is rotationally mounted to the housing 202 (see FIG. 2). The gear teeth 218 extend only partially about the circumference of the crank wheel 216 for reasons that will become apparent hereinafter. In the illustrated example the gear teeth 218 extend between 150 degrees and 180 degrees about the circumference of the crank wheel 216. Therefore, the motor 210 is operable to rotate the crank wheel 216 through between 150 degrees and 180 degrees, clockwise and counter-clockwise.

The crank wheel 216 also includes an arcuate slot 220. The arcuate slot 220 extends through the crank wheel 216 in the axial direction. The arcuate slot 220 has the same centre as the crank wheel 216. The arcuate slot 220 extends approximately 180 degrees about the crank wheel 216 and is arranged in the portion of the crank wheel 216 opposite to the gear teeth 218.

The arm 222a is connected to the arcuate slot 220 of the crank wheel 216. In particular, the arm 222a includes a slider 224 that is received in the arcuate slot 220. The slider 224 allows the arm 222a to rotate relative to the crank wheel 216, and the slider 224 can slide along the arcuate slot 220. In this way, the movement of the arm 222a is coupled to the crank wheel 216, as described below with reference to FIG. 4A to FIG. 4C. When two arms 222a, 222b are provided the slider 224 is preferably attached to both arms 222a, 222b.

FIG. 4A shows the door latch and opener 200 in the closed position. In this position the latch member 204 is in the closed position (first stable position) and the keeper 232 engages the striker 104 to hold the door closed in use.

As shown, in this position the crank wheel 216 is in a first rotational position. In this position the slider 224 of the arm 222a is at a first end of the arcuate slot 220 and the drive gear 214 sits at a first end of the gear teeth 218.

This is the normal operating position of the door latch and opener 200 while the dishwasher is being used. The door latch and opener 200 holds the door closed, but a user can still pull the door open as described above.

FIG. 4B shows the door latch and opener 200 in the open position. In this position the latch member 204 is in the open position (second stable position) and the keeper 232 disengages the striker 104 to allow the door to open under the spring force of the door hinge 108 described with reference to FIG. 1.

In order to move from the closed position (FIG. 4A) to the open position (FIG. 4B) the motor 210 rotates the drive gear 214, which rotates the crank wheel 216 (counter-clockwise as illustrated). As the slider 224 is at the first end of the arcuate slot 220 this rotation of the crank wheel 216 pulls the arm 222a, which rotates the latch member 204 from the closed position (first stable position) to the open position (second stable position). In other words, when the crank wheel 216 rotates it pulls down on the arm 222a and latch member 204 to open the door latch and opener 200.

After the door latch and opener 200 has moved to the open position the motor 210 is driven in the opposite direction to rotate the crank wheel 216 back to the initial position, as shown in FIG. 4C. In the illustrated view the motor 210 rotates the crank wheel 216 clockwise. During this rotation the arm 222a and latch member 204 remain in the open position, but the position of the crank wheel 216 is reset. As the crank wheel 216 rotates the slider 224 moves along the arcuate slot 220 to a position at or near a second end of the arcuate slot 220.

In this way, when the door is closed again, the striker 104 engages and rotates the latch member 204 (as described above), and the arm 222a can move freely without the crank wheel 216 because the slider 224 will slide along the arcuate slot 220 from the position shown in FIG. 4C to the position shown in FIG. 4A.

Accordingly, in operation of the opening mechanism 208 the crank wheel 216 is first rotated to move the latch member 204 from the closed position to the open position such that the door is opened, and then the crank wheel 216 is rotated in the opposite direction to reset the position of the crank wheel 216 for the next time that the door is closed.

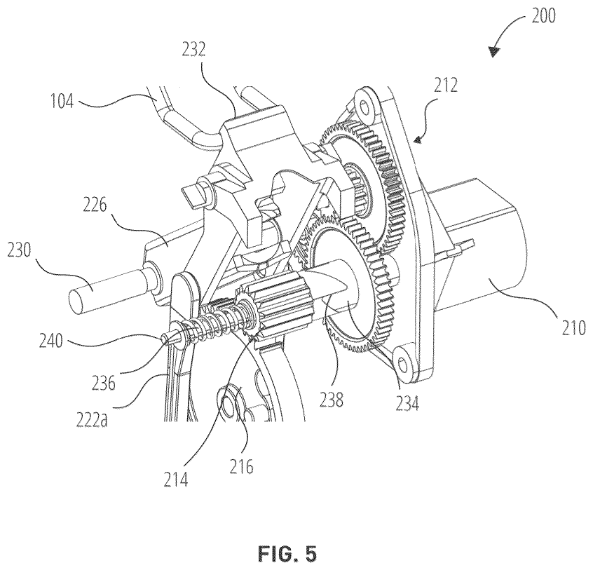

As shown in FIG. 2 and FIG. 3A, and most clearly in FIG. 5, the door latch and opener 200 also includes a torque-limiting coupling 234. The torque-limiting coupling 234 is arranged between the motor 210 and the crank wheel 216, and in this example between the gear train 212 and the drive gear 214. The torque-limiting coupling 234 includes angled teeth 238 that engage corresponding angled teeth 238 on one side of the drive gear 214. The drive gear 214 is slidably mounted on a rod 240, which provides the axle for the drive gear 214. The drive gear 214 can slide along the rod 240 and is biased towards the torque-limiting coupling 234 by spring 236. The angled teeth 238 of the torque-limiting coupling and the drive gear 214 are arranged to decouple in the event that the rotation of the latch member 204 is restricted or is forced against the action of the motor 210.

In the illustrated example, the torque-limiting coupling 234 is configured to decouple the drive gear 214 from the crank wheel 216 if the opening mechanism 208 (in particular the motor 210) is powered to move the latch member 204 from the closed position to the open position, but the door does not move or held closed, preventing the latch member 204 from rotating. This would increase the torque passing through the torque-limiting coupling 234, and the angled teeth 238 would push the drive gear 214 against the spring 236 and decouple the drive gear 214 from the crank wheel 216. This prevents damage to the door latch and opener 200 (in particular the crank wheel 216, drive gear 214, gear train 212, motor 210) if the door does not open as expected.

In other examples the torque-limiting coupling 234 may be configured to decouple the drive gear 214 and the crank wheel 216 if rotation in the opposite direction exceeded the torque needed to decouple the drive gear 214 from the crank wheel 216, for example if rotation of the latch member 204 is prevented from rotating from the open position to the closed position by the striker 104 being in the wrong position, or by an obstruction preventing the door from closing.

In other examples the torque-limiting coupling 234 may be configured to decouple based on increased torque in either rotational direction of the drive gear 214 and crank wheel 216.

The invention is not restricted to the details of any foregoing embodiments. Throughout the description and claims of this specification, the words “comprise” and “contain” and variations of them mean “including but not limited to”, and they are not intended to (and do not) exclude other moieties, additives, components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, or characteristics described in conjunction with a particular aspect, embodiment or example of the invention are to be understood to be applicable to any other aspect, embodiment or example described herein unless incompatible therewith. In particular, the words “certain embodiments” are to be understood to mean any embodiment described, illustrated, or otherwise disclosed herein, unless expressly stated otherwise. All of the features disclosed in this specification (including any accompanying claims, abstract and drawings), and/or all of the steps of any method or process so disclosed, may be combined in any combination, except combinations where at least some of such features and/or steps are mutually exclusive. The invention extends to any novel one, or any novel combination, of the features disclosed in this specification (including any accompanying claims, abstract and drawings), or to any novel one, or any novel combination, of the steps of any method or process so disclosed.

1. A door latch and opener (200) for a dishwasher (100) having a door (106), the door latch and opener comprising:
a latch member (204) for engagement with a striker (104) of the dishwasher, the latch member being movable between a closed position for holding the door closed and an open position for releasing the striker, and wherein preferably the latch member (204) is configured to be movable, by a force exerted by the striker (104) on the latch member (204), from the closed position and the open position, and from the open position to the closed position, and
an opening mechanism (208) comprising an actuator (210) coupled to the latch member and operable to move the latch member from the closed position to the open position.

2. The door latch and opener of claim 1, further comprising an over-centre spring opening mechanism (208) arranged to act on the latch member (204), the over-centre spring mechanism having a first stable position corresponding to the closed position of the latch member and a second stable position corresponding to the open position of the latch member.

3. The door latch and opener of claim 1, wherein the opening mechanism (208) comprises an arm (222a) coupled to the latch member (204), and wherein the actuator (210) is operable to act on the arm to move the latch member from the closed position to the open position.

4. The door latch and opener of claim 3, wherein the opening mechanism (208) further comprises a crank wheel (216), the arm being pivotally coupled to the latch member (204) and pivotally coupled to the crank wheel, and wherein the actuator (210) is arranged to rotate the crank wheel to move the latch member from the closed position to the open position.

5. The door latch and opener of claim 4, wherein the crank wheel (216) comprises an arcuate slot (220), and wherein the arm (222a) comprises a slider (224) that is slidably coupled to the arcuate slot of the crank wheel.

6. The door latch and opener of claim 5, wherein the opening mechanism (208) is configured to:
rotate the crank wheel (216) in a first direction to move the latch member (204) from the closed position to the open position, during which movement the slider (224) of the arm (222a) is at a first end of the arcuate slot (220), and
rotate the crank wheel in a second direction, opposite the first direction, to move the slider to a second position within the arcuate slot while the latch member remains in the open position.

7. The door latch and opener of claim 1, wherein the opening mechanism (208) comprises a torque-limiting coupling (234) arranged between the actuator (210) and the crank wheel (216).

8. An appliance, for example a dishwasher (100), comprising:
a cabinet (102) having a striker (104), and
a door (106) pivotably mounted to the cabinet and comprising the door latch and opener (200) of claim 1.

9. The appliance of claim 8, comprising a spring acting on the door (106) and urging the door towards an open position.
